(19) United States
(12) Patent Application Publication
(10) Pub. No.: US 2016/0029217 A1
(43) Pub. Date: Jan. 28, 2016

(54) SECURING WIRELESS CONNECTIONS USING LOCATION-SPECIFIC CONTEXTUAL INFORMATION

(71) Applicant: QUALCOMM Incorporated, San Diego, CA (US)

(72) Inventor: Seungwoo Yoo, Seoul (KR)

(21) Appl. No.: 14/338,703

(22) Filed: Jul. 23, 2014

(51) Int. Cl. H04W 12/08

(52) U.S. Cl. CPC H04W 12/08; H04W 64/00

(57) ABSTRACT

A mobile wireless device detects a first wireless device that seems to be a known access point. Location-specific contextual information for the first wireless device is identified. A wireless connection with the first wireless device is established if it is determined that the location-specific contextual information for the first wireless device matches known location-specific contextual information for the access point. A wireless connection with the first wireless device is not established, or is only established after receiving user confirmation, if it is determined that the location-specific contextual information for the first wireless device does not match the known location-specific contextual information for the access point.

### TECHNICAL FIELD

The present embodiments relate generally to wireless communications, and specifically to determining whether wireless connections are secure.

### BACKGROUND OF RELATED ART

A hacker may steal personal information by using a hostile wireless device that presents itself as a known access point. Because the hostile wireless device seems to be a known access point, mobile devices may connect with the hostile wireless device, which can then steal data from the mobile devices. Accordingly, there is a need for techniques to help ensure that wireless (e.g., WiFi) connections are secure.

### SUMMARY

In some embodiments, a method of securing wireless communications is performed in a mobile wireless device. In the method, a first wireless device is detected that seems to be a known first access point. Location-specific contextual information for the first wireless device is identified. A wireless connection with the first wireless device is established in response to a determination that the location-specific contextual information for the first wireless device matches known location-specific contextual information for the first access point.

In some embodiments, a wireless device includes one or more antennas, a wireless modem to transmit and receive signals through the one or more antennas, one or more processors, and memory storing one or more programs configured for execution by the one or more processors. The one or more programs include instructions to identify location-specific contextual information for a detected wireless device that seems to be a known access point and instructions to establish a wireless connection with the detected wireless device in response to a determination that the location-specific contextual information for the detected wireless device matches known location-specific contextual information for the access point. The one or more programs also include instructions to block establishment of a wireless connection with the detected wireless device or to request user confirmation before establishing a wireless connection with the detected wireless device, in response to a determination that the location-specific contextual information for the detected wireless device does not match the location-specific contextual information for the access point.

In some embodiments, a non-transitory computer-readable storage medium stores one or more programs configured for execution by one or more processors in a mobile wireless device. The one or more programs include instructions to identify location-specific contextual information for a detected wireless device that seems to be a known access point and instructions to establish a wireless connection with the detected wireless device in response to a determination that the location-specific contextual information for the detected wireless device matches known location-specific contextual information for the access point. The one or more programs also include instructions to block establishment of a wireless connection with the detected wireless device or to request user confirmation before establishing a wireless connection with the detected wireless device, in response to a determination that the location-specific contextual information for the detected wireless device does not match the location-specific contextual information for the access point.

### BRIEF DESCRIPTION OF THE DRAWINGS

The present embodiments are illustrated by way of example and are not intended to be limited by the figures of the accompanying drawings.

FIG. 1 is a block diagram of a wireless network in accordance with some embodiments.

FIG. 2 is a block diagram of a wireless network in which a hostile wireless device masquerades as an access point, in accordance with some embodiments.

FIGS. 3A-3C show a flowchart of a method of securing wireless communications in accordance with some embodiments.

FIG. 4 is a block diagram of a station in a wireless network in accordance with some embodiments.

Like reference numerals refer to corresponding parts throughout the drawings and specification.

### DETAILED DESCRIPTION

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

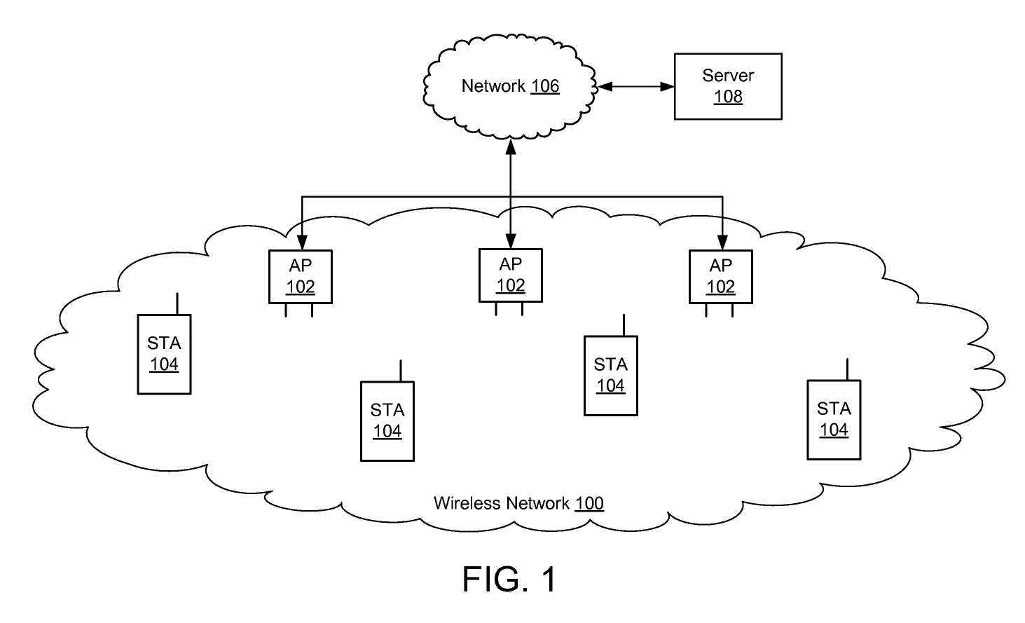

FIG. 1 is a block diagram of a wireless network 100 in accordance with some embodiments. The wireless network 100 includes access points (APs) 102 and stations (STAs) 104. A respective STA 104 may be a mobile wireless computing device (e.g., a cell phone, tablet computer, laptop computer, etc.). While FIG. 1 shows three APs 102 and four STAs 104, in general the number of APs 102 and STAs 104 in the wireless network 100 may vary. Each STA 104 may communicate with a respective AP 102 if it is within range of the AP 102 and has wirelessly connected with the AP 102. Transmissions from an AP 102 to a STA 104 are referred to as downlink transmissions. Transmissions from a STA 104 to an AP 102 are referred to as uplink transmissions.

The APs 102 may provide the STAs 104 with access to one or more networks 106 beyond the wireless network 100, and thus serve as gateways to one or more wider networks 106. For example, the APs 102 may provide the STAs 104 with access to a wide-area network (WAN), metropolitan-area network (MAN), campus network, and/or the Internet. The STAs 104 may access a remote server 108 through the APs 102 and network 106. The APs 102 thus act as wireless hot spots.

In some embodiments, the wireless network 100 is a wireless local area network (WLAN). For example, the wireless network 100 may be a WiFi network that operates in accordance with one or more protocols in the IEEE 802.11 family of protocols. WiFi, however, is only one example of a type of wireless protocol that may be used to implement the wireless network 100; other examples are possible.

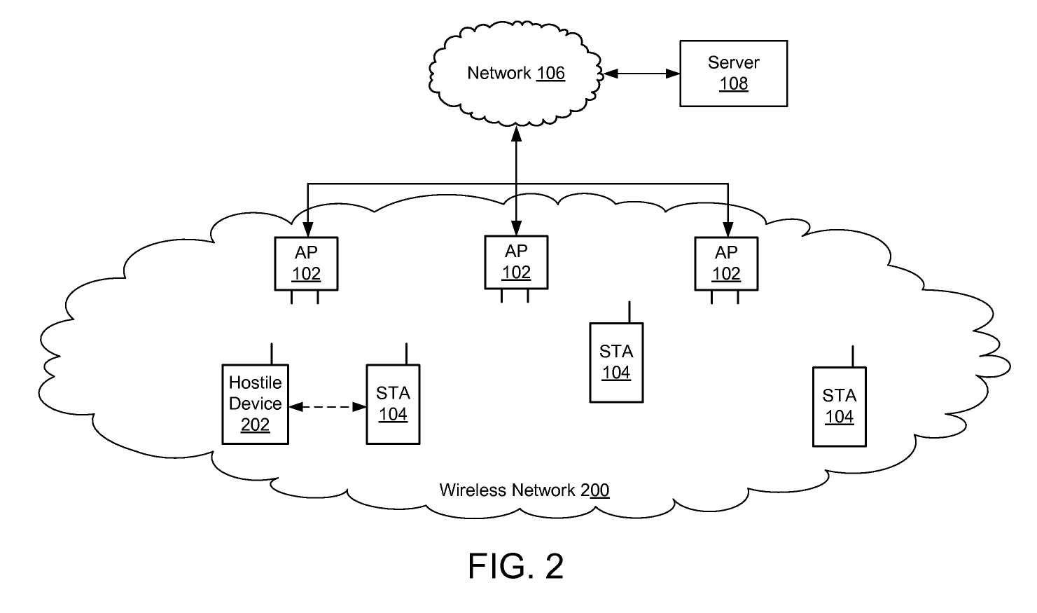

FIG. 2 is a block diagram of a wireless network 200 in accordance with some embodiments. The wireless network 200 is an example of a wireless network 100 (FIG. 1) that further includes a hostile wireless device 202. The hostile wireless device 202 masquerades as, and thus seems to be, an AP 102 (e.g., an AP 102 located elsewhere, such as in another wireless network in a location distinct from the location of the wireless network 200). The hostile wireless device 202 may seem to be an AP 102 that is known to at least some of the STAs 104 in the wireless network 200: the hostile wireless device 202 masquerades as an AP 102 to which these STAs 104 have previously connected. For example, the hostile wireless device 202 may use an identifier (e.g., a basic service set identifier, or BSSID) (e.g., a media-access-control (MAC) address) and/or password stolen from an AP 102. By masquerading as a known AP 102, the hostile wireless device 202 may fool STAs 104 into wirelessly connecting with it. The hostile wireless device 202 may then steal information from the STAs 104.

A STA 104 may prevent or reduce the likelihood of this sort of information theft by storing location-specific contextual information associated with respective APs 102 to which the STA 104 has previously connected. Upon detecting a wireless device that seems to be a known AP 102, the STA 104 uses one or more sensors to identify location-specific contextual information for the wireless device. The STA 104 retrieves the stored location-specific contextual information for the AP 102 in question, and compares it to the newly identified location-specific contextual information for the wireless device. If there is a match (e.g., to within a specified degree), then the STA 104 proceeds to connect with the wireless device. If there is not a match, then the STA 104 blocks establishment of the connection, or provides a warning and asks its user whether to proceed with the connection. Examples of location-specific contextual information that may be used in this manner include, but are not limited to, position data, images, recorded sound, wireless signal distributions, and measured power levels of wireless signals. Identifiers associated with APs 102 (e.g., BSSIDs/MAC addresses), however, are not considered to be location-specific contextual information, since they are unrelated to location. Similarly, passwords for APs 102 are not considered to be location-specific contextual information, since they are unrelated to location.

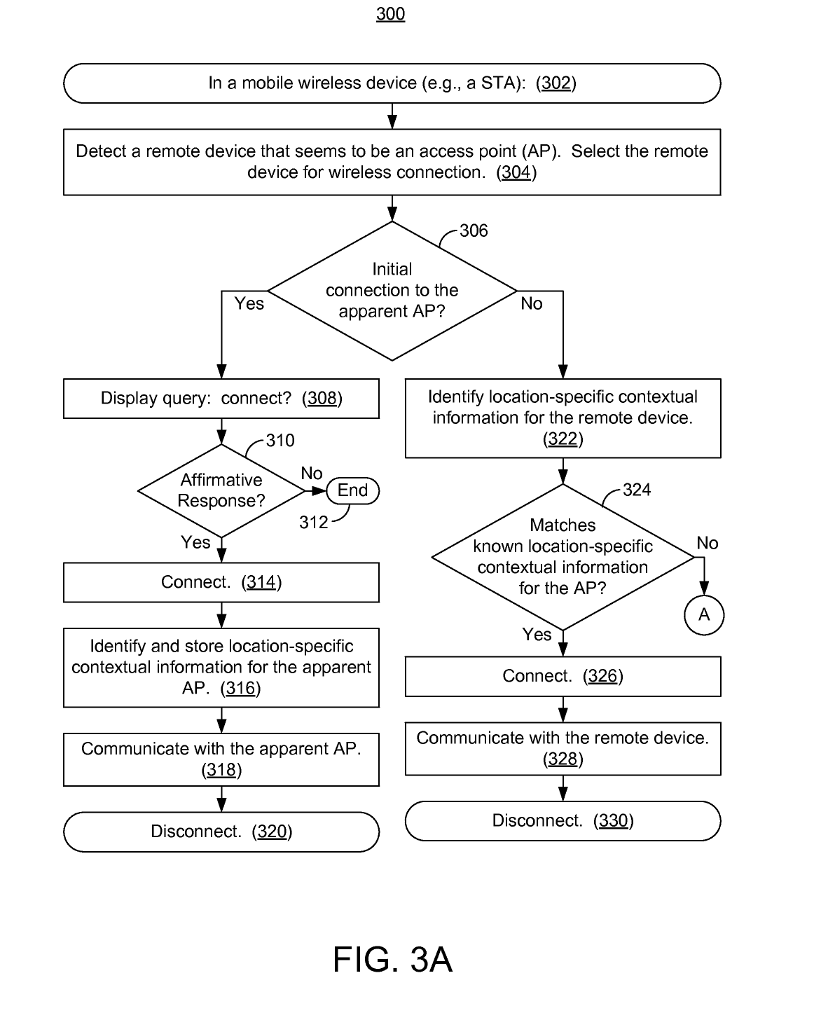

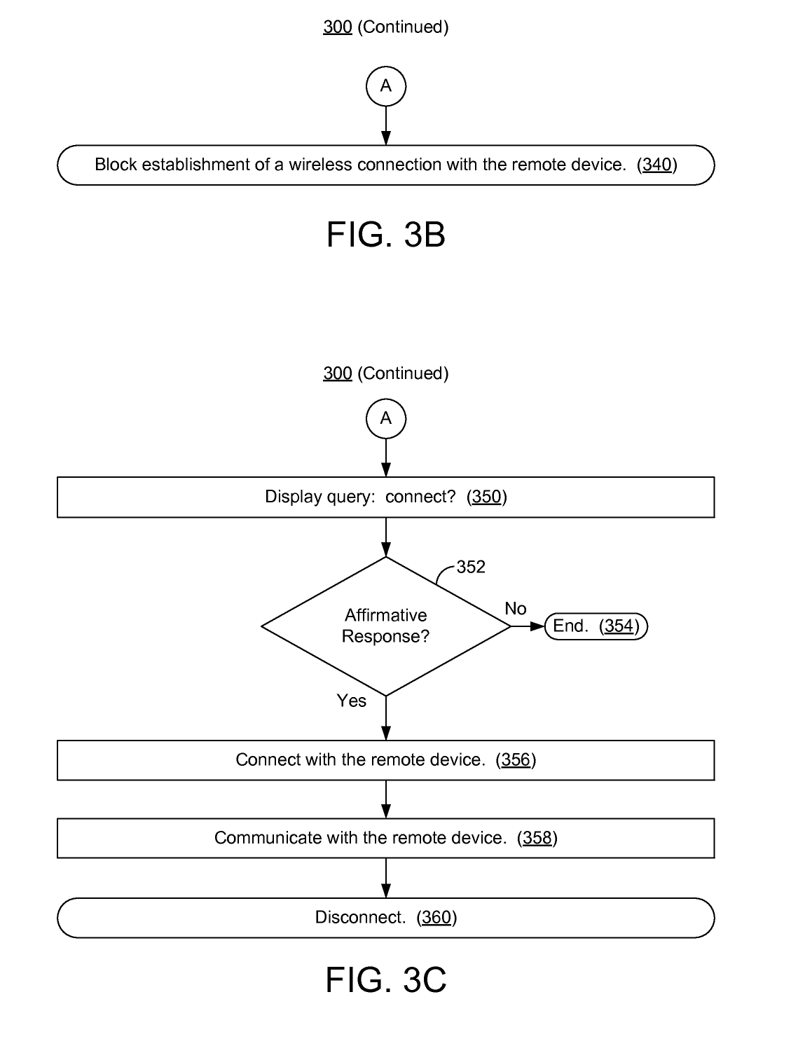

FIGS. 3A-3C show a flowchart of a method 300 of securing wireless communications in accordance with some embodiments. (FIGS. 3B and 3C show two alternatives for a portion of the method 300). The method 300 is performed (302) by a STA 104 in the wireless network 100 (FIG. 1) or 200 (FIG. 2), and thus by a mobile wireless device.

In the method 300, the STA 104 detects (304) a remote device that seems to be an AP 102. The remote device is a wireless device distinct from the STA 104. For example, a STA 104 detects the remote device by actively or passively scanning for APs 102 in its vicinity. In some embodiments, the remote device purports to have an identifier (e.g., a BSSID) (e.g., a MAC address) that is the identifier for an AP 102. While the remote device is apparently an AP 102, it could instead be a hostile wireless device 202 (FIG. 2). The STA 104 selects (304) the remote device for wireless connection.

The STA 104 determines (306) whether it has previously connected to the AP 102 that the remote device seems to be (the “apparent AP 102”), and thus whether the apparent AP 102 is known to the STA 104.

If the wireless connection would be an initial connection to the apparent AP (306-Yes), such that the apparent AP 102 is not known to the STA 104, then the STA 104 displays (308) a query asking its user whether to proceed with the connection. If an input received by the STA 104 indicates (310-No) that the user responds “no,” then the STA 104 does not connect to the remote device and the method 300 ends (312). If an input received by the STA 104 indicates (310-Yes) that the user responds “yes,” then the STA 104 wirelessly connects (314) with the remote device, which at this point is assumed to be the apparent AP 102. The STA 104 identifies (e.g., using one or more sensors) and stores (316) location-specific contextual information for the apparent AP 102. The STA 104 proceeds to communicate (318) with the apparent AP 102 and eventually disconnects (320) from the apparent AP 102.

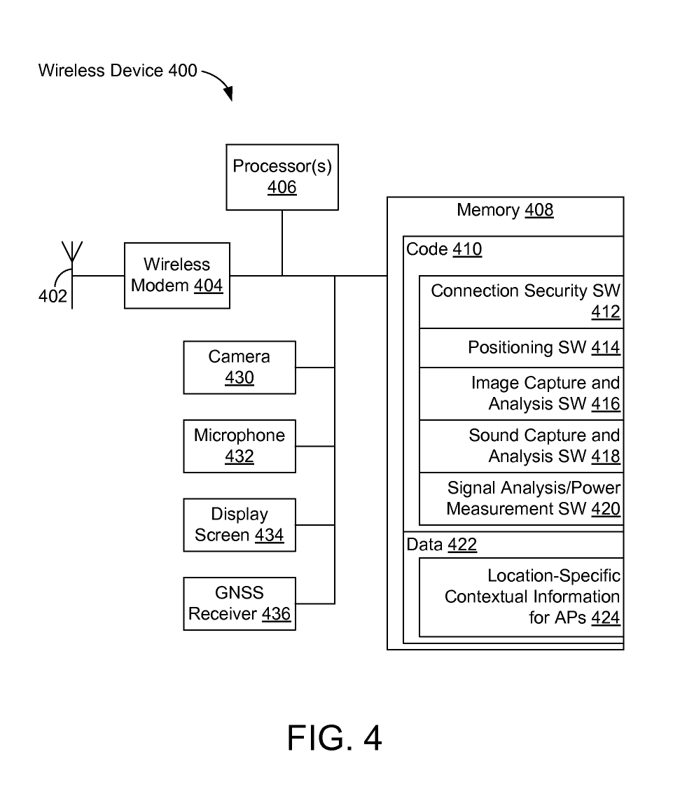

In some embodiments, the STA 104 stores (316) the identified location-specific contextual information in memory (e.g., memory 408, FIG. 4) in the STA 104. This memory may be non-volatile, such that the location-specific contextual information remains available if the STA 104 is turned off and then on again. Alternatively, the STA 104 stores (316) the identified location-specific contextual information remotely: the STA 104 transmits the location-specific contextual information to a remote computer system (e.g., remote server 108, FIGS. 1-2) for storage.

In some embodiments, the identified location-specific contextual information includes a location. For example, the STA 104 determines its location and associates its location with the apparent AP 102. The STA 104 may determine its location using a global navigation satellite system (GNSS) (e.g., the global positioning system, or GPS), a trilateration technique that uses received signal strength indicators (RSSIs), or other suitable technique. In another example, the STA 104 receives (e.g., from the apparent AP 102) and stores a location of the apparent AP 102 or a defined region (e.g., a geofence) that includes the apparent AP 102.

In some embodiments, the identified location-specific contextual information includes one or more images taken by the STA 104. The STA 104 may take one or more pictures of the surroundings of the STA 104 when within range of the apparent AP 102. These pictures thus capture portions of the vicinity of the apparent AP 102. A camera 430 (FIG. 4) in the STA 104 takes the one or more pictures, for example, in response to detecting and/or connecting to the apparent AP 102 or in an always-on mode.

In some embodiments, the identified location-specific contextual information includes sound recorded by the STA 104 while within range of the apparent AP 102. A microphone 432 (FIG. 4) in the STA 104 records the sound, for example, in response to detecting and/or connecting to the apparent AP 102 or in an always-on mode.

In some embodiments, the identified location-specific contextual information includes a wireless signal distribution (e.g., including power information and/or channel information) as detected by the STA 104 while within range of the apparent AP 102. For example, the STA 104 detects a distribution of WLAN signals (e.g., WiFi signals), which may include signals from multiple APs 102.

In some embodiments, the identified location-specific contextual information includes measurements of wireless signal power as detected by the STA 104 while within range of the apparent AP 102. For example, the STA 104 detects the power of wireless signals from base stations. These wireless signals thus may be signals for cellular communication in accordance with some embodiments.

In some embodiments, multiple types of location-specific contextual information for the apparent AP 102 are identified and stored.

If the STA 104 has previously connected to the apparent AP (306-No), such that the apparent AP 102 is known to the STA 104, then the STA 104 identifies (322) location-specific contextual information for the remote device (e.g., using one or more sensors). For example, the STA 104 determines its own location while within range of the remote device (e.g., using a GNSS, RSSI-based trilateration, or other technique). A camera 430 or microphone 432 (FIG. 4) may respectively take pictures or record sounds, for example, in response to the determination 306-No or in an always-on mode. In another example, the STA 104 takes one or more pictures and/or records sound while within range of the remote device. In yet another example, the STA 104 detects a wireless signal distribution and/or measures wireless signal power while within range of the remote device. Furthermore, the STA 104 may identify multiple types of location-specific contextual information for the remote device.

The STA 104 determines (324) whether the location-specific contextual information for the remote device, as identified in operation 322, matches known location-specific information for the apparent AP 102. To make this determination, the STA 104 retrieves the known location-specific contextual information for the apparent AP 102. If this information is stored in memory in the STA 104, it is read from memory. If this information is stored in a remote computer system (e.g., remote server 108, FIGS. 1-2), it is downloaded from the remote computer system. (Alternatively, the STA 104 may send the identified location-specific contextual information for the apparent AP 102 to a remote server 108, which may make the determination and provide the result to the STA 104.) The STA 104 compares the retrieved location-specific contextual information to the location-specific contextual information identified in operation 322. In some embodiments, the determination 324 involves calculating a degree of similarity between the location-specific contextual information for the remote device, as identified in operation 322, and the known location-specific information for the apparent AP 102, and determining whether the degree of similarity satisfies a criterion. The criterion may be a fixed threshold or a threshold that varies during operation of the STA 104 (e.g., in accordance with a machine-learning algorithm).

For example, the STA 104 determines whether its location is within a specified distance of a location associated with the apparent AP 102 (e.g., as identified and stored in operation 316), or within a specified region associated with the apparent AP 102 (e.g., a geofence) (e.g., as identified and stored in operation 316).

In another example, the STA 104 determines whether one or more stored pictures associated with the apparent AP 102 (e.g., as taken in operation 316) match one or more pictures taken in operation 322, to within a specified degree of similarity. This analysis may use a bag-of-features analysis, a pyramid matching scheme, or other image analysis technique.

In another example, the STA 104 determines whether sound associated with the apparent AP 102 (e.g., as recorded in operation 316) matches sound recorded in operation 322, to within a specified degree of similarity. This analysis may use mel-frequency cepstral coefficients, a matching pursuit algorithm, or other sound analysis technique.

In still other examples, the STA 104 determines whether a wireless signal distribution and/or wireless power measurements associated with the apparent AP 102 (e.g., as identified in operation 316) match a wireless signal distribution and/or wireless power measurements identified in operation 322, to within a specified degree of similarity.

Furthermore, the STA 104 may determine whether multiple types of location-specific contextual information associated with the apparent AP 102 (e.g., as identified in operation 316) match multiple types of location-specific contextual information identified in operation 322.

If the location-specific contextual information identified in operation 322 matches the known location-specific contextual information (324-Yes), then the STA 104 proceeds to connect (326) with the remote device, which is now assumed to be the apparent AP 102. The match provides confidence that the remote device actually is an AP 102 to which the STA 104 has previously connected (i.e., actually is the apparent AP 102). Accordingly, the match suggests that the connection is likely to be secure. The STA 104 communicates (328) with the remote device and eventually disconnects (330) from the remote device.

In some embodiments, if the identified location-specific contextual information does not match the known location-specific contextual information (324-No), then the STA 104 blocks (340, FIG. 3B) establishment of a wireless connection with the remote device. The mismatch suggests that the remote device may not actually be the AP 102 to which the STA 104 previously connected (i.e., may not be the apparent AP 102), but instead may be a hostile wireless device 202. In this situation, blocking establishment of the wireless connection prevents the hostile wireless device 202 from stealing information from the STA 104.

In other embodiments, if the identified location-specific contextual information does not match the known location-specific contextual information (324-No), then the STA 104 displays (350, FIG. 3C) a query asking its user whether to proceed with the connection. The STA 104 may display a warning along with the query to alert the user to the security risk indicated by the mismatch. If an input received by the STA 104 indicates (352-No) that the user responds “no,” then the STA 104 does not connect to the remote device and the method 300 ends (354). If an input received by the STA 104 indicates (352-Yes) that the user responds “yes,” then the STA 104 wirelessly connects (356) with the remote device. The STA 104 proceeds to communicate (358) with the remote device and eventually disconnects (360) from the remote device. The user of the STA 104 thus may be warned of a potential security risk and given the opportunity to decide whether or not to connect. For example, the user may know, based on his location, that the apparent AP 102 is likely actually an AP 102, and therefore may choose to connect, despite the mismatch.

While the method 300 includes a number of operations that appear to occur in a specific order, it should be apparent that the method 300 can include more or fewer operations. Some operations can be executed serially or in parallel, an order of two or more operations may be changed, performance of two or more operations may overlap, and two or more operations may be combined into a single operation.

FIG. 4 is a block diagram of a wireless device 400 in accordance with some embodiments. In some embodiments, the wireless device 400 is an example of a STA 104 (FIGS. 1 and 2). The wireless device 400 includes one or more antennas 402 coupled to a wireless modem 404 that transmits and receives signals through the one or more antennas 402. The wireless device 400 also includes memory 408 and one or more processors 406. The memory 408 may include non-volatile memory and volatile memory. The memory 408 (e.g., the non-volatile portion) stores code 410 configured for execution by the one or more processors 406. The code 410 thus may be stored in a non-transitory computer-readable storage medium (e.g., the non-volatile memory) in the memory 408.

The code 410 includes one or more programs with instructions configured for execution by the one or more processors 406. The one or more programs include connection security software 412 for ensuring that wireless connections are secure, positioning software 414 for determining locations of the wireless device 400 and comparing locations, image capture and analysis software 416 to take and compare pictures, sound capture and analysis software 418 to record and compare sounds, and/or signal analysis/power measurement software 420. The signal analysis/power measurement software 420 identifies wireless signal distributions and/or measures power levels of wireless signals, and performs comparisons of wireless signal distributions and/or power measurements. The software 412, 414, 416, 418, and/or 420 collectively includes instructions for performing all or a portion of the method 300 (FIGS. 3A-3C) and thus for achieving the functionality of a STA 104 as described herein.

The memory 408 also stores data 422 to be referenced by the one or more processors 406 when executing the code 410. The data 422 includes location-specific contextual information 424 (e.g., as identified in operations 316 and/or 322, FIG. 3A) for APs 102.

The wireless device 400 has various sensors, including a camera 430, microphone 432, and/or GNSS receiver 436. The antenna(s) 402 also may be considered a sensor. In addition, the wireless device 400 has a display screen 434.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of securing wireless communications, comprising:
in a mobile wireless device:
detecting a first wireless device that seems to be a known first access point;
identifying location-specific contextual information for the first wireless device; and
establishing a wireless connection with the first wireless device in response to a determination that the location-specific contextual information for the first wireless device matches known location-specific contextual information for the first access point.

2. The method of claim 1, further comprising, in the mobile wireless device, making the determination that the location-specific contextual information for the first wireless device matches known location-specific contextual information for the first access point;
wherein making the determination comprises:
calculating a degree of similarity between the location-specific contextual information for the first wireless device and the location-specific contextual information for the first access point; and
determining that the degree of similarity satisfies a criterion.

3. The method of claim 1, wherein:
the first access point has a first identifier; and
the first wireless device purports to have the first identifier.

4. The method of claim 3, wherein the first identifier comprises a basic service set identifier.

5. The method of claim 1, wherein:
identifying the location-specific contextual information for the first wireless device comprises determining a location of the mobile wireless device when the mobile wireless device is within range of the first wireless device; and
the location-specific contextual information for the first access point comprises a location of the mobile wireless device when the mobile wireless device was previously within range of the first access point.

6. The method of claim 1, wherein:
identifying the location-specific contextual information for the first wireless device comprises taking a first picture when the mobile wireless device is within range of the first wireless device; and
the location-specific contextual information for the first access point comprises a second picture taken when the mobile wireless device was previously within range of the first access point.

7. The method of claim 1, wherein:
identifying the location-specific contextual information for the first wireless device comprises recording sound when the mobile wireless device is within range of the first wireless device; and
the location-specific contextual information for the first access point comprises sound recorded when the mobile wireless device was previously within range of the first access point.

8. The method of claim 1, wherein:
identifying the location-specific contextual information for the first wireless device comprises identifying a wireless signal distribution when the mobile wireless device is within range of the first wireless device; and
the location-specific contextual information for the first access point comprises a wireless signal distribution identified when the mobile wireless device was previously within range of the first access point.

9. The method of claim 1, wherein:
identifying the location-specific contextual information for the first wireless device comprises measuring wireless signal power when the mobile wireless device is within range of the first wireless device; and
the location-specific contextual information for the first access point comprises wireless signal power measured when the mobile wireless device was previously within range of the first access point.

10. The method of claim 1, further comprising, in the mobile wireless device, before detecting the first wireless device that seems to be the first access point:
wirelessly connecting with the first access point;
identifying the location-specific contextual information for the first access point;
storing the location-specific contextual information for the first access point; and
disconnecting from the first access point.

11. The method of claim 10, wherein wirelessly connecting with the first access point comprises establishing an initial wireless connection with the first access point.

12. The method of claim 11, further comprising, in the mobile wireless device, before establishing the initial wireless connection with the first access point:
displaying a query regarding whether to establish the initial wireless connection; and
receiving an affirmative input in response to the query;
wherein the initial wireless connection is established in response to the affirmative input.

13. The method of claim 10, wherein:
storing the location-specific contextual information for the first access point comprises saving the location-specific contextual information for the first access point in memory in the mobile wireless device; and
the method further comprises:
reading the location-specific contextual information for the first access point from the memory; and
comparing the location-specific contextual information for the first access point, as read from the memory, to the location-specific contextual information for the first wireless device.

14. The method of claim 10, wherein:
storing the location-specific contextual information for the first access point comprises sending the location-specific contextual information for the first access point to a remote computer system for storage; and
the method further comprises:
retrieving the location-specific contextual information for the first access point from the remote computer system; and
comparing the retrieved location-specific contextual information for the first access point to the location-specific contextual information for the first wireless device.

15. The method of claim 1, further comprising, in the mobile wireless device:
detecting a second wireless device that seems to be a known second access point;
identifying location-specific contextual information for the second wireless device; and
blocking establishment of a wireless connection with the second wireless device in response to a mismatch between the location-specific contextual information for the second wireless device and known location-specific contextual information for the second access point.

16. The method of claim 1, further comprising, in the mobile wireless device:
detecting a second wireless device that seems to be a known second access point;
identifying location-specific contextual information for the second wireless device;
in response to a mismatch between the location-specific contextual information for the second wireless device and known location-specific contextual information for the second access point, displaying a query regarding whether to establish a wireless connection with the second wireless device;
receiving an input in response to the query; and
using the input to decide whether to establish the wireless connection with the second wireless device.

17. A wireless device, comprising:
one or more antennas;
a wireless modem to transmit and receive signals through the one or more antennas;
one or more processors; and
memory storing one or more programs configured for execution by the one or more processors, the one or more programs comprising:
instructions to identify location-specific contextual information for a detected wireless device that seems to be a known access point;
instructions to establish a wireless connection with the detected wireless device in response to a determination that the location-specific contextual information for the detected wireless device matches known location-specific contextual information for the access point; and
instructions to block establishment of a wireless connection with the detected wireless device or to request user confirmation before establishing a wireless connection with the detected wireless device, in response to a determination that the location-specific contextual information for the detected wireless device does not match the location-specific contextual information for the access point.

18. The wireless device of claim 17, wherein the one or more programs further comprise:
instructions to identify and store the location-specific contextual information for the access point in conjunction with establishment of an initial wireless connection with the access point.

19. A non-transitory computer-readable storage medium storing one or more programs configured for execution by one or more processors in a mobile wireless device, the one or more programs comprising:
instructions to identify location-specific contextual information for a detected wireless device that seems to be a known access point;
instructions to establish a wireless connection with the detected wireless device in response to a determination that the location-specific contextual information for the detected wireless device matches known location-specific contextual information for the access point; and
instructions to block establishment of a wireless connection with the detected wireless device or to request user confirmation before establishing a wireless connection with the detected wireless device, in response to a determination that the location-specific contextual information for the detected wireless device does not match the location-specific contextual information for the access point.

20. The computer-readable storage medium of claim 19, wherein the one or more programs further comprise:
instructions to identify and store the location-specific contextual information for the access point in conjunction with establishment of an initial wireless connection with the access point.
